(19) United States
(12) Patent Application Publication
(10) Pub. No.: US 2018/0064130 A1
(43) Pub. Date: Mar. 8, 2018

(54) COMBINED PROTEIN AND FRUIT PRODUCT AND METHOD OF MAKING A COMBINED PROTEIN AND FRUIT PRODUCT

(71) Applicant: THE HERSHEY COMPANY, Hershey, PA (US)

(72) Inventors: Julie Emsing MANN, Annville, PA (US); Gagan MONGIA, Hummelstown, PA (US)

(21) Appl. No.: 15/551,326

(22) PCT Filed: Feb. 18, 2016
(86) PCT No.: PCT/US2016/018461

§ 371 Date: Aug. 16, 2017

Related U.S. Application Data
(60) Provisional application No. 62/118,763, filed on Feb. 20, 2015.

(51) Int. Cl. A23G 3/48; A23G 3/44; A23L 19/00; A23L 29/231; A23L 29/269; A23L 33/185; A23L 33/19; A23L 5/00

(52) U.S. Cl. CPC A23G 3/48; A23G 3/44; A23L 19/09; A23L 5/51; A23L 29/27; A23L 33/185; A23L 33/19; A23L 29/231

(57) ABSTRACT

A method of making a solid, combined protein and fruit product includes preparing a concentrated protein mixture including at least one concentrated protein, adding at least one concentrated fruit to the concentrated protein mixture to form a protein and fruit mixture, and removing water from the protein and fruit mixture to reach a predetermined solids level for the solid, combined protein and fruit product. In some embodiments, the concentrated protein mixture includes at least one hydrocolloid agent. A solid, combined protein and fruit product includes a concentrated protein and a concentrated fruit mixed with the concentrated protein. The concentrated protein in the solid, combined protein and fruit product is minimally denatured and the solid, combined protein and fruit product does not harden during the shelf life of the solid, combined protein and fruit product.

### CROSS-REFERENCE TO RELATED APPLICATIONS

This application claims priority to and the benefit of U.S. Provisional Application No. 62/118,763 filed Feb. 20, 2015, which is hereby incorporated by reference in its entirety.

### FIELD

This application is directed to a comestible product and a method of making the same. More particularly, the present invention is directed to combined protein and fruit products.

### BACKGROUND

Consumers often look for snacks and other comestible products that are, or are perceived to be, a healthier alternative and which often include fruit. Known comestible fruit products often contain mainly sugar, corn syrup, starch, a hydrocolloid or gelling agent, flavor, color, and acid. Recently, more “natural” or healthy versions have emerged containing a new range of ingredients including fruit purees and fruit concentrates to substitute for the typical corn syrup and sugar. However, even among the more recent options, it is unknown to provide a combination of one or more concentrated fruit-rich ingredients and one or more concentrated, isolated, enriched protein-rich ingredients, which presents a host of difficulties, particularly when attempting to form a snack delivering both fruit and protein benefits in a concentrated, single serving.

One difficulty associated with the production of protein and fruit combinations is the ability to add protein to an acidic product. Many fruits are naturally acidic, and the formation of fruit purees and fruit concentrates only increases the acidity of the fruit product. When the protein is added directly to the acidic fruit concentrate or fruit puree, the acid changes the conformation or otherwise significantly denatures the protein, forming a product that is neither stable nor desirable.

Another difficulty associated with the production of protein and fruit combinations is the heat involved in the production of the fruit-rich ingredient. Fruit-rich products are typically produced by cooking the mixture to a high percentage of solids (80-85%), and then depositing the mixture into starch molds, or extruding/slabbing to form ropes, tubes, or sheets. As with adding protein to acidic products, the exposure of protein to high heat during cooking denatures the protein, particularly in the presence of high acid levels.

Exemplary embodiments overcome such problems and are directed to a combined protein and fruit product and methods of making a combined protein and fruit product.

### SUMMARY

According to an exemplary embodiment, a method of making a combined protein and fruit product includes preparing a concentrated protein mixture including at least one concentrated protein and at least one hydrocolloid agent, adding at least one concentrated fruit to the concentrated protein mixture to form a protein and fruit mixture, and removing water from the protein and fruit mixture to reach a predetermined solids level for the combined protein and fruit product.

According to another exemplary embodiment, a method of making a combined protein and fruit product includes preparing a concentrated protein mixture including at least one concentrated protein, adding at least one concentrated fruit to the concentrated protein mixture to form a protein and fruit mixture, and removing water from the protein and fruit mixture to form the combined protein and fruit product. The concentrated protein in the combined protein and fruit product is not coagulated, and the combined protein and fruit product does not harden during a shelf life of the combined protein and fruit product.

According to another exemplary embodiment, a combined protein and fruit product includes a concentrated protein and a concentrated fruit mixed with the concentrated protein. The concentrated protein in the combined protein and fruit product is not coagulated, and the combined protein and fruit product does not harden during a shelf life of the combined protein and fruit product.

Among the advantages of exemplary embodiments is that methods described herein produce a comestible product including a combination of fruit-rich ingredients and protein-rich ingredients. Despite the combination of protein-rich ingredients with the acidic fruit-rich ingredients, exemplary embodiments exhibit minimal denaturing of the protein from the protein-rich ingredients.

Another advantage is that the methods produce solid shelf-stable protein and fruit products at ambient temperatures.

Still another advantage is that the methods produce solid stabilized protein and fruit products, where the fruit ingredients and the protein ingredients balance the moisture distribution to maintain a texture of the product over time, without the typical drying out and/or hardening that high solids protein products normally exhibit.

A further advantage is that the methods provide heating of a protein and fruit mixture without completely denaturing the protein ingredients.

Other features and advantages of the present invention will be apparent from the following more detailed description of exemplary embodiments that illustrate, by way of example, the principles of the invention.

### DETAILED DESCRIPTION OF EXEMPLARY EMBODIMENTS

Exemplary embodiments are directed to combined protein and fruit products. Such comestibles provide both protein and fruit benefits in a single serving without the negative effects of acid on protein.

Accordingly, embodiments of the present disclosure, in comparison to methods and snacks not using one or more of the features disclosed herein, combine conventionally-incompatible protein and fruit systems, provide a shelf-stable protein and fruit product, reduce protein hardening, provide a moisture sharing system, reduce a denaturing of protein, or a combination thereof.

In one embodiment, a method of making a combined protein and fruit product includes preparing a protein mixture, adding one or more fruit ingredients to the protein mixture to form a protein and fruit mixture, and then forming the protein and fruit product. In another embodiment, the method includes heating the protein and fruit mixture, and then forming the protein and fruit product. In a further embodiment, glycerine is also added during the method. The glycerine may be added at any point before, during, and/or after preparing the protein mixture. As discussed in detail below, the method facilitates combining of and/or heating conventionally-incompatible concentrated fruit and concentrated protein systems to form the protein and fruit product.

Although described herein primarily with reference to fruit in combination with protein, it will be appreciated by those skilled in the art that the method is not so limited, and may be applied to any combination of protein with acidic ingredients. As used herein, the term acidic ingredient refers to any ingredient having a pH of 6 or below.

Preparing the protein mixture includes forming a dry blend, hydrating the dry blend in water to form a hydrated mixture, and adding protein to the hydrated mixture to form the protein mixture. The dry blend preferably includes at least one hydrocolloid agent and may optionally include at least one saccharide. Suitable hydrocolloid agents include, but are not limited to, pectin, xanthan gum, carrageenan, any other hydrocolloid agent to reduce or eliminate clumping of the protein, or a combination thereof. Any suitable saccharide may be used, including, but not limited to, a monosaccharide, a disaccharide, an oligosaccharide, or a combination thereof. The dry blend is hydrated under shear to form the hydrated mixture, which may be stored at a temperature of at least 49° C. (120° F.).

The dry blend optionally includes sugar in an amount of up to about 50% by weight of the hydrated mixture prior to protein addition. Pectin (or other hydrocolloids) are typically present in the range of about 10 to about 15% by weight of the hydrated mixture, again prior to protein addition.

Protein is then slowly mixed into the hydrated mixture, resulting in the dispersion of the protein within the hydrated mixture. The hydrated mixture hydrates the dispersed protein, resulting in an even distribution that avoids lumping of the protein. The protein is generally added as a protein concentrate (at least 80% wt protein) or protein isolate (at least 90% wt protein), although in some embodiments, protein flours having at least 50% wt protein may also be employed. Exemplary protein sources include, but are not limited to, soy, pea, dairy, yogurt, Greek yogurt, chickpea, canola, faba bean, brown rice, white rice, lentils, algae, quinoa, or a combination thereof. The protein may be either in an intact or a hydrolyzed form. The protein is added to the hydrated mixture, and the presence of the hydrocolloid agent results in stabilization of the protein. This in turn reduces or minimizes protein denaturing. This process results in the protein being charge-stabilized and homogenized in forming the protein mixture prior to addition of the fruit, resulting in the ability to combine the two without coagulation.

The denaturing of a protein occurs on a spectrum as the protein unfolds to increasingly greater degrees from native quaternary, tertiary, and secondary structures. While some degree of denaturing is unavoidable when processing foods containing proteins, minimizing protein denaturing or minimally denatured protein, as used herein, refers to processing the protein in a manner such that the protein is less than 50% denatured, and in some cases as little as 10% to 20% denatured. A minimal amount of denaturing may be beneficial for solubility or structuring, but excessive denaturing leads to coagulation, precipitation, curdling, and/or formation of insoluble clumps of the protein, which makes the protein useless for food systems in many cases.

After forming the protein mixture, one or more fruit ingredients are added to form the protein and fruit mixture. The one or more fruit ingredients include any fruit-rich ingredient, such as, but not limited to, a fruit puree (having a solid concentration equal to or up to approximately three to five times that of the unprocessed fruit), a fruit concentrate (having a solid concentration approximately six to seven times that of the unprocessed fruit), or a combination thereof. The fruit puree may be a single strength fruit puree having approximately the same solids percentage as the original whole fruit. Alternatively, the fruit puree may be a concentrated puree, such as, for example a double strength or triple strength fruit puree, having a higher concentration of solids, such as, for example, twice, three times, or more than three times the concentration of the solids in the original whole fruit as a result of removing water from the single strength fruit puree.

As shown in Table 1 below, the fruit-rich ingredients may include, for example, a strawberry puree, a strawberry concentrate, an apple puree, an apple concentrate, a pear puree, a pear concentrate, a grape puree, a grape concentrate, or a combination thereof, although any other fruits or acidic vegetables may also be used, such as, for example, a pumpkin puree and/or pumpkin concentrate. The values listed in Table 1 for purees are for single strength versions of the purees. In one embodiment, the fruit-rich ingredient has a hydrophilic matrix. In another embodiment, the fruit-rich ingredient includes an increased solid content and/or acidity as compared to non-concentrated fruit. For example, a fruit concentrate may include between 65% and 71% solids and a pH in the range of 3.0 to 4.4. A fruit puree may, for example, have a pH in the range from 3.0 to 4.0 and between 9% and 20% solids for a single strength version or between 20% and 35% solids for a double strength version.

TABLE 1

| Fruit and Fruit Juice | % | % | | Acidity Range |
|---|---|---|---|---|
| Concentrates | moisture | solids | pH | (wt/wt) |
| Strawberry puree | 90 | 10 | 3.0-3.9 | |
| Strawberry concentrate | 35 | 65 | 3.1-3.6 | 5.0-8.0 as malic |
| Apple puree | 85 | 15 | 3.3-3.9 | |
| Apple concentrate | 30 | 70 | 3.2-4.4 | 1.2-3.6 as malic |
| Pear puree | 84 | 16 | 3.5-4.6 | |
| Pear concentrate | 30 | 70 | 3.2-4.4 | 1-2.3 as malic |
| Concord grape puree | 80 | 20 | 2.9-3.8 | |
| Concord grape concentrate | 32 | 68 | 2.9-3.7 | 1.7-3.5 as tartaric |

The hydrating and/or stabilizing of the protein in the protein mixture reduces or minimizes denaturing of the protein by the addition of the acidic ingredients and/or the one or more fruit ingredients. By reducing or minimizing denaturing of the protein, the hydrating and/or stabilizing maintains or substantially maintains the structure, conformation, and/or functionality of the protein. In one embodiment, the hydrocolloid agent complexes and/or stabilizes together the one or more fruit ingredients and the protein ingredient. The addition of the one or more fruit ingredients to the protein mixture forms the protein and fruit mixture, which includes a homogenous mass with fully hydrated protein.

In one embodiment, the method includes heating the protein and fruit mixture. Heating of the protein and fruit mixture reduces moisture content and increases the percentage of solids in the mixture. In some embodiments, heating the protein and fruit mixture increases the percentage of solids in the mixture to at least about 65% by weight, more typically to at least about 75% by weight, and preferably in the range of about 80% to about 85% by weight.

The protein and fruit mixture may be heated by any device suitable for evaporating a portion of the water in the mixture, such as, but not limited to, a vacuum cooker. For example, in one embodiment, the protein and fruit mixture is heated in a vacuum kettle to between about 72° C. (162° F.) and about 84° C. (183° F.) for about a half hour. The hydrating and/or stabilizing of the protein and/or the fruit ingredients reduces or minimizes a denaturing of the protein during the heating.

In another embodiment, the protein may be provided in a hydrolyzed form and added after the hydrocolloid agent and concentrated fruit are combined. A hydrolyzed protein, as used herein, refers to a protein having been hydrolyzed to any degree to break at least one peptide bond of the original protein such that the hydrolyzed protein has a lower average molecular weight than the original protein.

After any heating of the protein and fruit mixture, forming the protein and fruit product includes cooling followed by drop rolling, slabbing, drying, or any other desired processing and/or shaping steps. Drying the protein and fruit mixture further reduces the moisture content to achieve a solid product having a predetermined water activity (a_{w}) and, surprisingly, not drying out. Subsequent to heating and/or drying, the final protein and fruit product typically includes a water activity (a_{w}) of between 0.4 and 0.7, more typically between 0.45 and 0.65, preferably between 0.48 and 0.6, and most preferably between 0.5 and 0.55. In one embodiment, the heating and/or the drying of the protein and fruit mixture adjusts the water activity to facilitate coating of the protein and fruit product. The moisture content of the final protein and fruit product is typically between 5% and 30%, more typically between 10% and 25%, and preferably between about 12% and 20%, providing a shelf-stable, solid protein and fruit product that does not require refrigeration.

The method may also include incorporating various additives as may be desired into the protein and fruit product. The additives include any additional ingredient to provide additional stabilization, texture, and/or flavor to the combined protein and fruit product, and are typically incorporated into the protein and fruit mixture prior to forming the protein and fruit product. For example, various additives may be included during and/or after heating the protein and fruit mixture, prior to cooling or otherwise forming the final protein and fruit product. Suitable additives include, but are not limited to, sweeteners, fibers, malic acid solutions, flavorants, or a combination thereof.

The concentrated protein and fruit product includes a concentrated protein and a concentrated fruit mixed with the concentrated protein. The concentrated protein is preferably part of a concentrated protein mixture that is formed before the concentrated fruit is added. The concentrated protein mixture preferably also includes one or more of at least one hydrocolloid agent, glycerine, and water. In some embodiments, the concentrated protein mixture also includes at least one sugar. In some embodiments, the protein and fruit mixture includes, prior to cooking, the concentrated protein in the range of about 5 to 16% by weight, the concentrated fruit in the range of about 30 to 65% by weight including about 5 to 35% fruit solids, optionally sugar in the range of 3 to 15% by weight, hydrocolloid agent in the range of about 0.1 to 3% by weight, glycerine in the range of about 6 to 9% by weight, optionally acid in the range of about 1 to 2% by weight, optionally flavor up to about 0.1% by weight, and additional water in the range of about 12 to 24% by weight. In some embodiments, the combined protein and fruit product may also include a predetermined amount of fat, which may be in the form of an oil, such as a plant-based oil. The amount of fat, by weight, when present in the protein and fruit mixture, may be in the range of 1 to 15%, alternatively in the range of 4-12%, alternatively in the range of 7 to 10%, or any range or sub-range thereof. After the concentrated protein mixture is mixed with the concentrated fruit to form a protein and fruit mixture, a predetermined amount of water is removed from the protein and fruit mixture to form the concentrated protein and fruit product.

Throughout the shelf life of the protein and fruit product, the moisture-releasing properties of the protein ingredients are balanced by the moisture binding properties of the fruit ingredients. In some embodiments, the shelf life is at least 12 months. The moisture balancing creates a sharing and/or equilibrating of moisture throughout the shelf life of the protein and fruit product, forming a moisture-enhanced, stable matrix or system. The moisture system reduces or eliminates a hardening and/or toughening of the protein, facilitating production of various platforms and formats, such as, but not limited to, chewy snack products, layers, extruded sheets, tubes, spherical snacks, or a combination thereof. The moisture system may be formed from any suitable composition of protein ingredients and fruit ingredients. For example, the protein and fruit product may include, by weight, between 5% and 95% fruit-rich ingredients, between 5% and 95% protein ingredients, and a balance of additives.

### EXAMPLES

The invention is further described in the context of the following examples, which are presented by way of illustration, not of limitation.

In each of Examples 1-7, the method was carried out as follows. A dry blend of the sugar and the hydrocolloid agent was hydrated in water at about 100° C. (about 212° F.) under shear and then stored at about 49° C. (about 120° F.). The protein was added to the hydrated sugar and hydrocolloid mixture to hydrate the protein. The protein-sugar-hydrocolloid mixture was mixed slowly to ensure dispersion of the protein in the mixture. The glycerine was then added to the protein-sugar-hydrocolloid mixture.

The fruit was then added to the mixture and the mixture was heated to remove water while stirring, either on a bench-top cooker or in a vacuum cooker. The cooking was continued until a target of 81% solids was reached, which took about 30 minutes in the vacuum cooker or about 55 to 60 minutes on the bench-top cooker. Optionally about 1% of an acid or about 0.05% of flavoring was added to the cooked mixture. The cooked mixture was then cooled, drop-rolled, slabbed, and dried as needed to further lower the moisture or reach a predetermined water activity level.

In Examples 8 and 9 the methods differed from that of Examples 1-7, as described in Examples 8 and 9.

### Example 1

In one example, the protein and fruit product was formed with apple juice concentrate as the fruit, soy protein concentrate as the protein, sucrose as the sugar, pectin as the hydrocolloid agent, and a malic acid solution as the acid. The protein and fruit product was prepared from the ingredients in the pre-cook formulation percentages by weight shown in Table 2 below.

TABLE 2

| Ingredients | Formulation % (pre-cook) |
|---|---|
| Apple juice concentrate | 50.57 |
| Soy protein concentrate | 13.07 |
| Water | 22.00 |
| Sucrose | 4.60 |
| Glycerine | 7.00 |
| Pectin | 1.69 |
| Malic acid solution (50) | 1.10 |

### Example 2

In another example, the protein and fruit product was formed with apple juice concentrate as the fruit, whey protein concentrate as the protein, sucrose as the sugar, pectin as the hydrocolloid agent, and a malic acid solution as the acid. The protein and fruit product was prepared from the ingredients in the pre-cook formulation percentages by weight shown in Table 3 below.

TABLE 3

| Ingredients | Formulation % (pre-cook) |
|---|---|
| Apple juice concentrate | 50.14 |
| Whey protein concentrate | 13.00 |
| Water | 23.00 |
| Sucrose | 4.00 |
| Glycerine | 6.90 |
| Pectin | 1.67 |
| Malic acid solution (50) | 1.29 |

### Example 3

In another example, the protein and fruit product was formed with strawberry puree, pear puree, and apple juice concentrate at a 2:1 ratio of fruit puree to fruit juice concentrate as the fruit, whey protein concentrate as the protein, sucrose as the sugar, pectin as the hydrocolloid agent, and a malic acid solution as the acid. The protein and fruit product was prepared from the ingredients in the pre-cook formulation percentages by weight shown in Table 4 below.

TABLE 4

| Ingredients | Formulation % (pre-cook) |
|---|---|
| Strawberry puree | 21.83 |
| Soy protein concentrate | 8.93 |
| Apple juice concentrate | 20.88 |
| Pear puree | 19.25 |
| Water | 12.90 |
| Sucrose | 5.46 |
| Glycerine | 8.23 |
| Pectin | 1.19 |
| Malic acid solution(50) | 1.29 |
| Flavor | 0.05 |

After cooking, the soy protein concentrate was about 12% of the mixture.

### Example 4

In another example, the protein and fruit product was formed with strawberry puree, pear puree, and apple juice concentrate at a 2:1 ratio of fruit puree to fruit juice concentrate as the fruit, whey protein concentrate as the protein, sucrose as the sugar, pectin as the hydrocolloid agent, and a malic acid solution as the acid. The protein and fruit product was prepared from the ingredients in the pre-cook formulation percentages by weight shown in Table 5 below. This mixture had a higher protein-to-fruit ratio than the mixture of Example 3.

TABLE 5

| Ingredients | Formulation % (pre-cook) |
|---|---|
| Strawberry puree | 17.82 |
| Soy protein concentrate | 15.06 |
| Apple juice concentrate | 18.82 |
| Pear puree | 15.38 |
| Water | 16.89 |
| Sucrose | 5.16 |
| Glycerine | 7.79 |
| Pectin | 1.88 |
| Malic acid solution (50) | 1.22 |

After cooking, the soy protein concentrate was about 18% of the mixture.

### Example 5

In another example, the protein and fruit product was formed with strawberry puree and apple juice concentrate as the fruit, pea protein as the protein, sucrose as the sugar, pectin as the hydrocolloid agent, and a malic acid solution as the acid. The protein and fruit product was prepared from the ingredients in the pre-cook formulation percentages by weight shown in Table 6 below.

TABLE 6

| Ingredients | Formulation % (pre-cook) |
|---|---|
| Strawberry puree | 19.68 |
| Pea protein | 12.05 |
| Apple juice concentrate | 19.73 |
| Pear puree | 17.24 |
| Water | 15.00 |
| Sucrose | 5.15 |
| Glycerine | 7.78 |
| Pectin | 1.87 |
| Malic acid solution (50) | 1.50 |

### Example 6

In another example, the protein and fruit product was formed with apple puree as the fruit, soy protein concentrate as the protein, sucrose as the sugar, pectin as the hydrocolloid agent, and a malic acid solution as the acid. The protein and fruit product was prepared from the ingredients in the pre-cook formulation percentages by weight shown in Table 7 below. In this example, the fruit was only puree with no fruit concentrate.

TABLE 7

| Ingredients | Formulation % (pre-cook) |
|---|---|
| Apple puree | 56.63 |
| Soy protein concentrate | 10.48 |
| Water | 16.00 |
| Sucrose | 5.36 |
| Glycerine | 8.25 |
| Pectin | 1.99 |
| Malic acid solution (50) | 1.29 |

### Example 7

In another example, the protein and fruit product was formed with pumpkin puree and apple juice concentrate as the fruit, soy protein concentrate as the protein, sucrose as the sugar, pectin as the hydrocolloid agent, and a malic acid solution as the acid. The protein and fruit product was prepared from the ingredients in the pre-cook formulation percentages by weight shown in Table 8 below.

TABLE 8

| Ingredients | Formulation % (pre-cook) |
|---|---|
| Pumpkin puree | 35.78 |
| Soy Protein concentrate | 11.83 |
| Apple juice concentrate | 22.02 |
| Water | 14.68 |
| Sucrose | 5.05 |
| Glycerine | 7.61 |
| Pectin | 1.84 |
| Malic acid solution (50) | 1.19 |

### Example 8

In another example, the protein and fruit product was formed with pear puree as the fruit, Greek yogurt powder as the protein, agave syrup as the sugar, and xanthan gum as the hydrocolloid agent. The ingredients also included whole milk powder, coconut oil, and lecithin. As the sugar was a liquid in this embodiment, the sugar-hydrocolloid agent mixture was not dry prior to adding the water. The protein and fruit product was prepared from the ingredients in the pre-cook formulation percentages by weight shown in Table 9 below.

TABLE 9

| Ingredients | Formulation % (pre-cook) |
|---|---|
| Greek yogurt powder | 14.51 |
| Agave syrup | 17.41 |
| Pear puree | 32.41 |
| Water | 16.25 |
| Whole milk powder | 3.0 |
| Glycerine | 6.9 |
| Coconut oil | 9.22 |
| Xanthan gum | 0.1 |
| Lecithin | 0.2 |

The whole milk powder added flavor to the protein and fruit product as well as some protein, fat, and creaminess. The coconut oil enhanced the flavor and provided a smooth and creamy texture in consumption of the protein and fruit product as well as adding some fat. Finally, the lecithin, as an emulsifier, brought together the water phase and the oil/fat phase to provide a stable single phase and prevented subsequent separation of the water from the oil/fat. The lecithin is an optional ingredient preferably included in protein and fruit products containing an ingredient providing oil or fat.

### Example 9

In another example, the protein and fruit product was formed with pear puree and apple juice concentrate as the fruit, soy protein concentrate as the protein, and xanthan gum as the hydrocolloid agent. No sugar was combined with the hydrocolloid agent prior to the hydration with water in this example. The protein and fruit product was prepared from the ingredients in the pre-cook formulation percentages by weight shown in Table 10 below.

TABLE 10

| Ingredients | Formulation % (pre-cook) |
|---|---|
| Soy protein concentrate | 9.89 |
| Apple juice concentrate | 21.98 |
| Pear puree | 39.96 |
| Water | 19.59 |
| Glycerine | 8.45 |
| Xanthan gum | 0.12 |

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of making a solid, combined protein and fruit product comprising:
preparing a concentrated protein mixture comprising at least one concentrated protein and at least one hydrocolloid agent;
adding at least one concentrated fruit to the concentrated protein mixture to form a protein and fruit mixture; and
removing water from the protein and fruit mixture to reach a predetermined solids level for the solid, combined protein and fruit product.

2. The method of claim 1, wherein the concentrated protein in the solid, combined protein and fruit product is minimally denatured and wherein the solid, combined protein and fruit product does not harden during a shelf life of the solid, combined protein and fruit product.

3. The method of claim 1, wherein preparing the concentrated protein mixture comprises mixing the hydrocolloid agent with water to form a hydrated agent and mixing the hydrated agent with the concentrated protein.

4. The method of claim 3, wherein the hydrated agent further comprises a sugar.

5. The method of claim 1, wherein the concentrated protein mixture further comprises glycerine.

6. The method of claim 1, wherein the predetermined solids level is at least 80% solids by weight.

7. The method of claim 1 further comprising adding at least one additive to the solid, combined protein and fruit product after removing water from the protein and fruit mixture, wherein the at least one additive is selected from the group consisting of a sweetener, a fiber, an acid, a flavor, and combinations thereof.

8. The method of claim 1, wherein a water activity of the solid, combined protein and fruit product is in the range of 0.4 to 0.7.

9. The method of claim 1, wherein removing water comprises heating the protein and fruit mixture while stirring the protein and fruit mixture.

10. The method of claim 1, wherein the hydrocolloid agent is selected from the group consisting of pectin, xanthan gum, carrageenan, and combinations thereof.

11. A method of making a solid, combined protein and fruit product comprising:
preparing a concentrated protein mixture comprising at least one concentrated protein;
adding at least one concentrated fruit to the concentrated protein mixture to form a protein and fruit mixture; and
removing water from the protein and fruit mixture to form the solid, combined protein and fruit product;
wherein the concentrated protein in the solid, combined protein and fruit product is not coagulated and wherein the solid, combined protein and fruit product does not harden during a shelf life of the solid, combined protein and fruit product.

12. The method of claim 11, wherein preparing the concentrated protein mixture comprises mixing a hydrocolloid agent with water to form a hydrated agent and mixing the hydrated agent with the concentrated protein.

13. The method of claim 12, wherein the hydrated agent further comprises a sugar.

14. The method of claim 12, wherein removing water comprises heating the protein and fruit mixture while stirring the protein and fruit mixture.

15. A solid, combined protein and fruit product comprising:
a concentrated protein; and
a concentrated fruit mixed with the concentrated protein;
wherein the concentrated protein in the solid, combined protein and fruit product is not coagulated and wherein the solid, combined protein and fruit product does not harden during a shelf life of the solid, combined protein and fruit product.

16. The solid, combined protein and fruit product of claim 15, wherein a water activity of the solid, combined protein and fruit product is in the range of 0.4 to 0.7.

17. The solid, combined protein and fruit product of claim 15, wherein the concentrated protein is from a source selected from the group consisting of soy, pea, dairy, yogurt, chickpea, canola, faba bean, brown rice, white rice, lentils, algae, quinoa, and combinations thereof.

18. The solid, combined protein and fruit product of claim 15, wherein the hydrocolloid agent is selected from the group consisting of pectin, xanthan gum, carrageenan, and combinations thereof.

19. The solid, combined protein and fruit product of claim 15, wherein the solid, combined protein and fruit product comprises at least 5% protein by weight and at least 5% fruit solids by weight.

20. The solid, combined protein and fruit product of claim 15, wherein a solids level of the combined protein and fruit product is at least 80% solids by weight.
